(19) United States
(12) Patent Application Publication
(10) Pub. No.: US 2016/0050852 A1
(43) Pub. Date: Feb. 25, 2016

(54) AGRICULTURAL ROBOT SYSTEM

(71) Applicant: Chul Hee LEE, Seoul (KR)

(72) Inventor: Chul Hee LEE, Seoul (KR)

(21) Appl. No.: 14/781,045

(22) PCT Filed: Mar. 21, 2014
(86) PCT No.: PCT/KR2014/002407

§ 371 Date: Sep. 29, 2015

(30) Foreign Application Priority Data
Mar. 29, 2013 (KR) 10-2013-0034049

(51) Int. Cl. A01G 3/00; B25J 9/16; H04N 7/18; G06T 7/00; G06K 9/46; B25J 15/00; B25J 9/02

(52) U.S. Cl. CPC A01G 3/00; B25J 15/0019; B25J 9/1697; B25J 9/023; B25J 9/1612; G06T 7/0004; G06K 9/46; H04N 7/18; Y10S 901/41; Y10S 901/16; A01G 2003/005; G06T 2207/30188; G06K 2009/4666

(57) ABSTRACT

The present invention relates to an agricultural robot system having a laser beam generator to cut peduncles or thin blossoms and, more particularly, to an agricultural robot system for recognizing fruits, flowers, or flower buds from camera input images and then scanning laser beams to cut peduncles or thin blossoms (burn or cure flowers or flower buds), thereby speeding up the operation, and the non-contact operation prevents damage to crops and contamination by viruses and germs and saves on labor.

### TECHNICAL FIELD

The present invention relates to an agricultural robot system, and in particular to an agricultural robot system which makes it possible to more quickly and sanitarily cut peduncles or thin blossoms (burn or cure flowers or flower buds) in such a way to radiate a laser beam through a galvano-scanner.

### BACKGROUND ART

Work, for example, harvesting, fluid thinning, flower thinning, flower bud thinning, etc. with respect to plants, for example, strawberry, grape, tomato, cherry, etc. has been done manually. In recent years, many parts of such labor are being done using a machine thanks to the developed growing technology, for example, nutriculture. There are still growing needs for a quick and sanitary mechanization while further enhancing a work efficiency and saving on labor.

For such needs, an apparatus has been developed and actually used, which is able to harvest fruits using a robot control technology which has converged an image processing technology, a motion control technology, etc. thanks to the development in an information process technology and a robot control technology.

A harvest apparatus which is being developed lately equips with an articulated manipulator wherein an end effector at a terminal of such a manipulator equips with a cutting device, for example, a knife, etc. for cutting peduncles. During the harvesting, the end effector contacts close to a fruit which will be harvested, thus cutting a peduncle by applying a physical force to the peduncle.

The price of the harvest apparatus is high due to the complicated structures of the manipulator and cutting device, and it takes a lot of time to move the end effector using the manipulator. Due to the size and structure of the end effector, it may contact with fruit, stem, leaves, etc. except for a peduncle cutting object, thus causing damages to the plants.

The cutting device, for example, scissors, a knife, etc. of the end effector may infect various virus or bacteria between the plants during the cutting of peduncles, so such a cutting device has bad effect on the sanitation of plants.

In addition, a recently developed blossom thinner is configured in such a way that a branch with blossom is strongly beaten by rotating an axle to which a plurality of wire are attached, whereupon the branches of a plant may be broken without blooming at a desired portion.

Meanwhile, the method for cutting peduncles or thinning blossoms may differ based on plants. For this reason, various kinds of a peduncle cutting robot are being developed. The Korean patent registration number 784830 describes a bent cultivation type strawberry harvesting system to harvest strawberry. The US patent registration number 4663925 describes a fruit harvesting robot hand to harvest fruits on a tree branch. The Japanese patent registration number 5360832 describes a peduncle removing and fruit harvesting apparatus. The Japanese patent registration numbers 3052470 and 3052471 describe a fruit harvesting robot to harvest cucumbers.

### DISCLOSURE OF INVENTION

Accordingly, the present invention is made in an effort to resolve the above-mentioned problems. It is an object of the present invention to provide an agricultural robot system which makes it possible to more quickly and sanitarily cut peduncles or thin blossoms in such a way to cut peduncles or burn blossoms (burning: to burn or cure) by radiating a laser beam through a galvano-scanner.

The present invention will be described below.

To achieve the above-object, there is provided an agricultural robot system, which may include, but is not limited to, a laser beam generator provided to generate a laser beam; a galvano-scanner configured to perform a peduncle cutting or blossom thinning work by radiating the laser beam from the laser beam generator; a camera which is installed facing a scanning surface of the galvano-scanner and is able to take pictures of fruits or flowers; an image collection unit which is able to take pictures of images containing the fruits or flowers from the camera; an image recognition unit which is able to recognize the fruits, peduncles and flowers from the images taken by the image collection unit; and a target region detection unit which is able to detect a peduncle cutting or blossom thinning target region from the image recognition information of the image recognition unit, wherein the laser beam scans the target region using the galvano-scanner based on the target region information detected by the target region detection unit, thus performing a peduncle cutting and blossom thinning work.

### Advantageous Effects

The present invention provides an agricultural robot system which allows to cut peduncles and thin blossoms in such a way to radiate a laser beam in a non-contact fashion using a galvano-scanner, thus preventing any damages to plants and infection of bacteria while obtaining quick work and saving on labor.

### BRIEF DESCRIPTION OF DRAWINGS

FIG. 1 is a view illustrating a part of a high bed farm in which an agricultural robot system and a strawberry harvesting device are installed according to an exemplary embodiment of the present invention.

FIG. 2 is a view illustrating an agricultural robot system according to an exemplary embodiment of the present invention.

FIG. 3 is a view illustrating an agricultural robot system wherein an end effector equips with a plurality of galvano-scanner and a camera according to an exemplary embodiment of the present invention.

FIG. 4 is a view illustrating a galvano-scanner and a laser beam generator according to an exemplary embodiment of the present invention.

FIG. 5 is a view illustrating a galvano-canner, a camera and a scanning surface according to an exemplary embodiment of the present invention.

FIG. 6 is a block diagram illustrating an inner control device of an agricultural robot system according to an exemplary embodiment of the present invention.

FIG. 7 is a flow chart for describing the flow of an agricultural robot system according to an exemplary embodiment of the present invention.

FIG. 8 is a view illustrating an input image for describing a peduncle cutting and blossom thinning target region according to an exemplary embodiment of the present invention.

FIG. 9 is a view for describing a peduncle cutting and blossom thinning target region according to an exemplary embodiment of the present invention.

FIG. 10 is a view illustrating a state where a delta robot is equipped instead of a galvano-scanner in an end-effector according to an exemplary embodiment of the present invention.

FIG. 11 is a view illustrating a state where an articulated robot is equipped instead of a support unit and a shaft according to an exemplary embodiment of the present invention.

FIG. 12 is a view illustrating a state where an articulated robot and a delta robot are equipped instead of a support unit, a shaft and a galvano-scanner in an end-effector according to an exemplary embodiment of the present invention.

*Legend of Reference Numbers*

| 10: Agricultural robot system | |
|---|---|
| 100: Main body | 110: Tray |
| 120: Transfer unit | 130: Fruit collection disposal port |
| 140: Support unit | 150: Connection unit |
| 160: Ascending and descending and rotation shaft | |
| 170: Universal type container | |
| 180: Wheel | 190: Rail |
| 200: End-effector | 210: Scanner |
| 211: X-axis mirror motor | 212: X-axis mirror |
| 213: Y-axis mirror motor | 214: Y-axis mirror |
| 220: Camera | 230: Lighting |
| 240: Spray nozzle | 250: Laser beam generator |
| 251: Laser beam | 255: Scanning surface |
| 252: Peduncle cutting target region | |
| 253: Blossom thinning target region | |
| 290: Delta robot | 291: Articulated robot |
| 300 Hopper | 310: Laser beam shield plate |
| 320: Fruit sorting unit | |
| 400: Cultivation support unit | 410: Legs |
| 500: Red fruits | 501: Peduncle |
| 510: Green fruits 520: Flower | |
| 530: Flower buds | 540: Flower stalk |

### BEST MODES FOR CARRYING OUT THE INVENTION

The preferred exemplary embodiments of the present invention will be described with reference to the accompanying drawings. The plants, a fruit cultivation method, and the sizes, materials, shapes and relative arrangements of configuration components disclosed in the present preferred exemplary embodiment of the present invention are just simplified descriptions, not limiting the scope of the present invention unless otherwise stated herein.

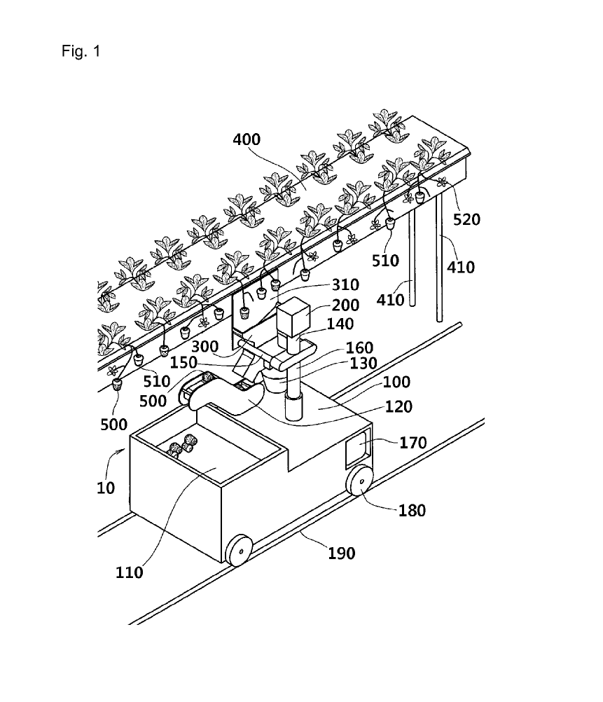

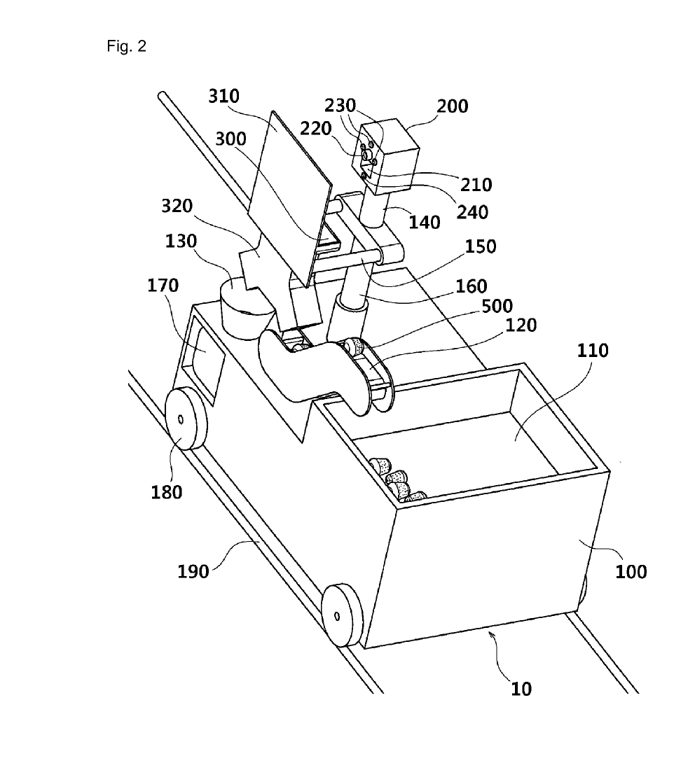

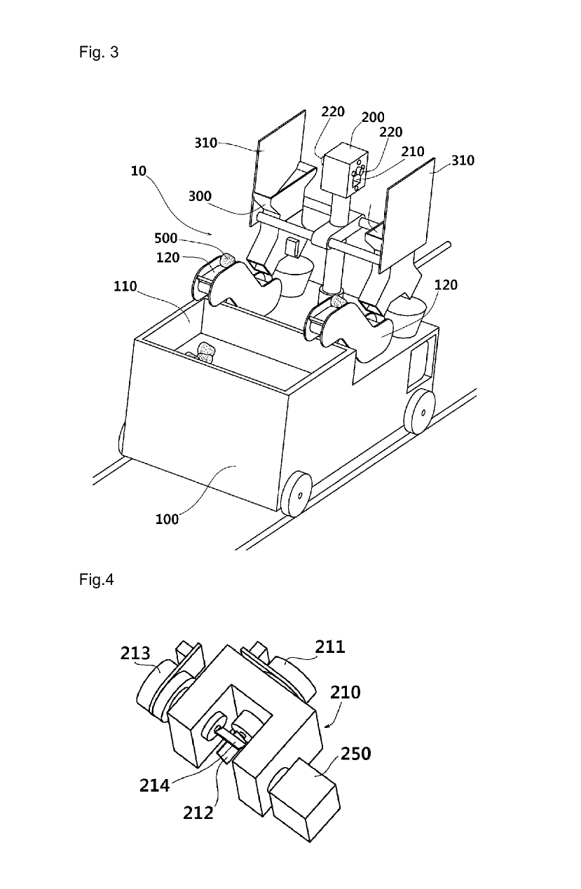

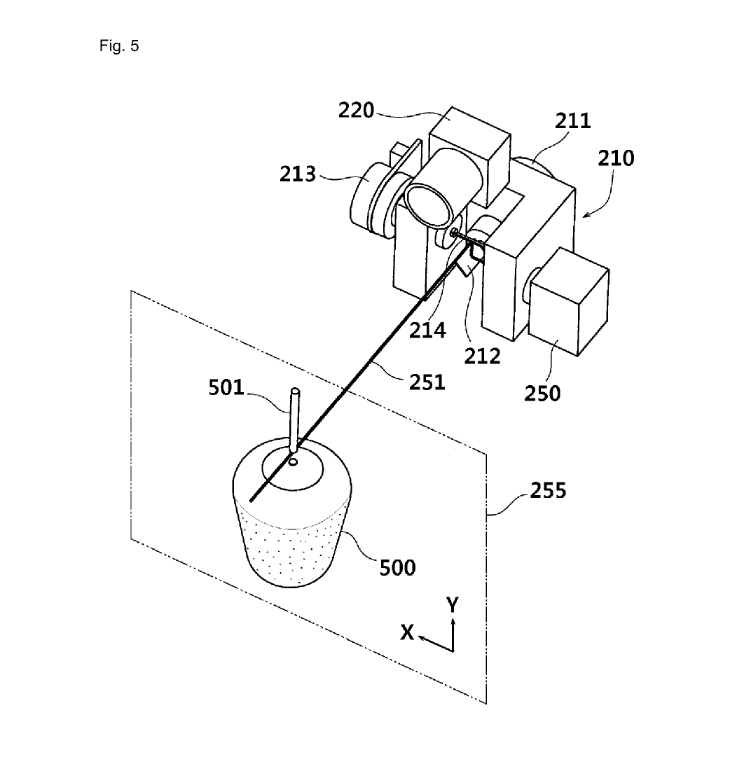

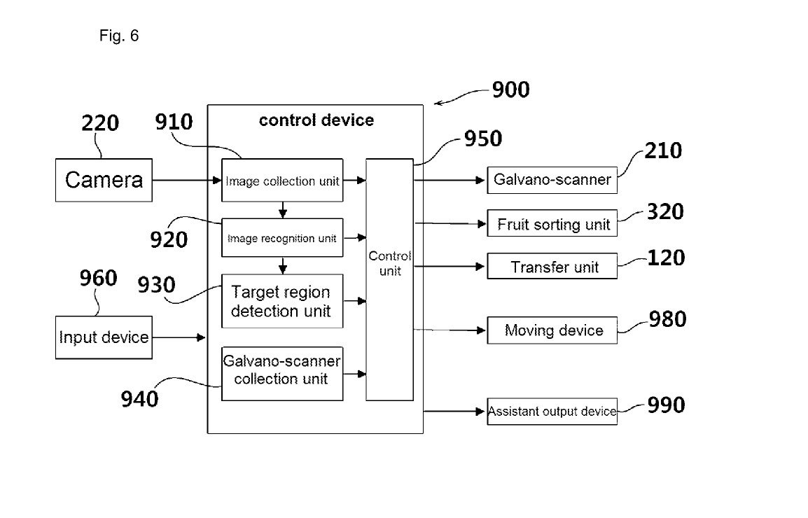

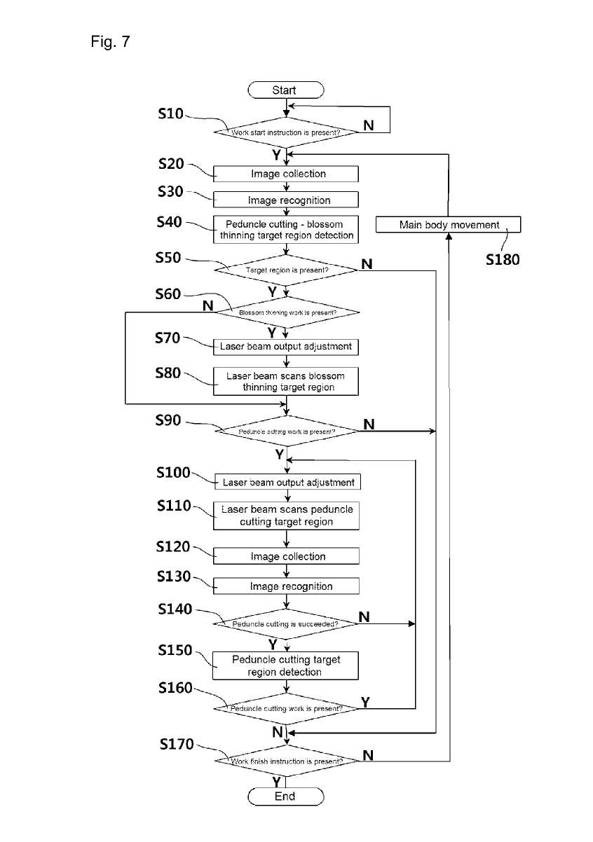

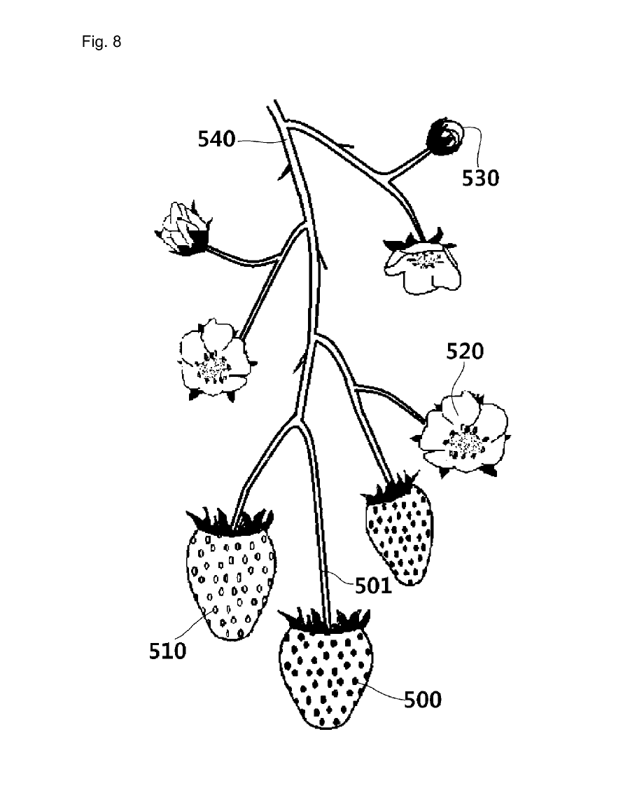

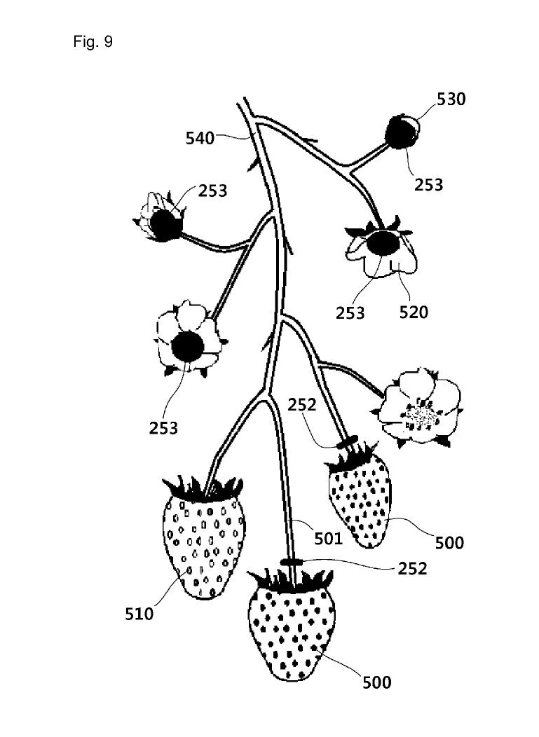

FIG. 1 is a view illustrating a part of a high bed farm in which an agricultural robot system and a strawberry harvesting device are installed according to an exemplary embodiment of the present invention. FIG. 2 is a view illustrating an agricultural robot system according to an exemplary embodiment of the present invention. FIG. 3 is a view illustrating an agricultural robot system wherein an end effector equips with a plurality of galvano-scanner and a camera according to an exemplary embodiment of the present invention. FIG. 4 is a view illustrating a galvano-scanner and a laser beam generator according to an exemplary embodiment of the present invention. FIG. 5 is a view illustrating a galvano-canner, a camera and a scanning surface according to an exemplary embodiment of the present invention. FIG. 6 is a block diagram illustrating an inner control device of an agricultural robot system according to an exemplary embodiment of the present invention. FIG. 7 is a flow chart for describing the flow of an agricultural robot system according to an exemplary embodiment of the present invention. FIG. 8 is a view illustrating an input image for describing a peduncle cutting and blossom thinning target region according to an exemplary embodiment of the present invention. FIG. 9 is a view for describing a peduncle cutting and blossom thinning target region according to an exemplary embodiment of the present invention.

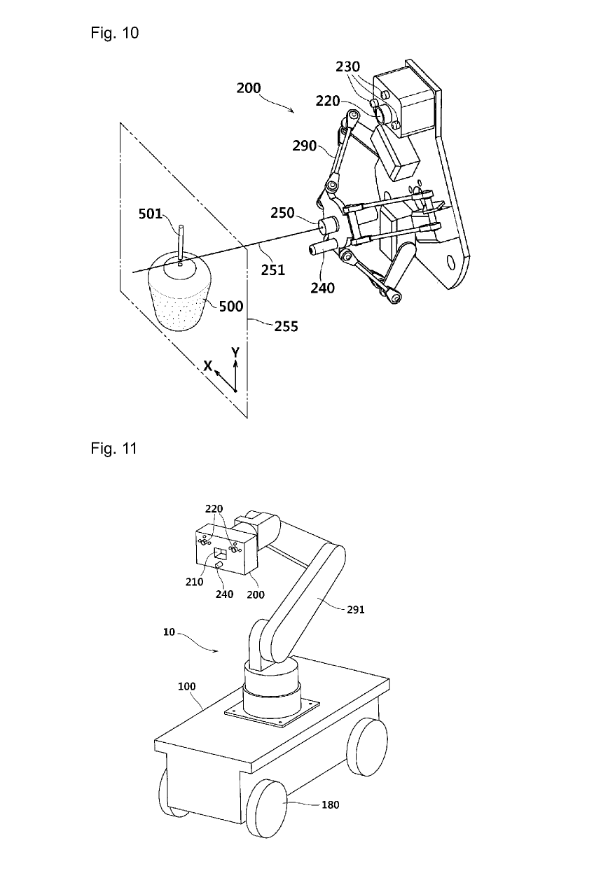

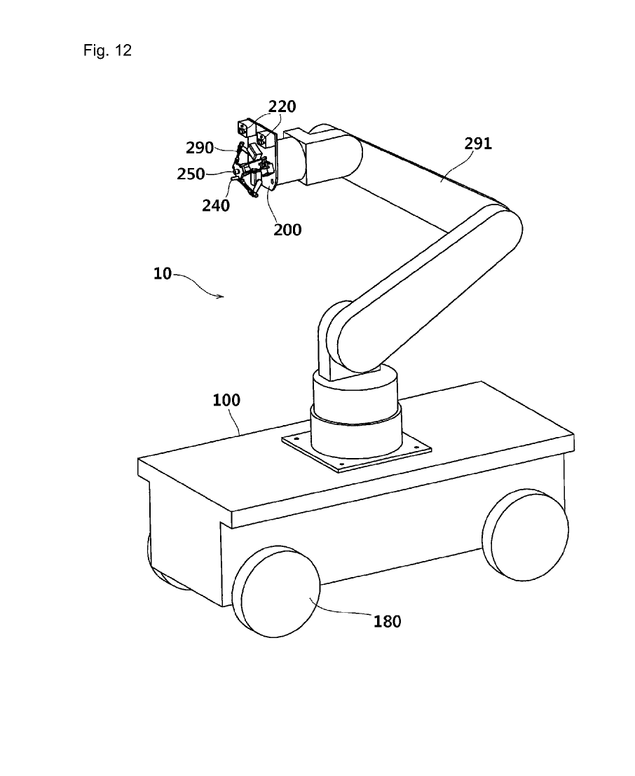

In addition, FIG. 10 is a view illustrating a state where a delta robot is equipped instead of a galvano-scanner in an end-effector according to an exemplary embodiment of the present invention. FIG. 11 is a view illustrating a state where an articulated robot is equipped instead of a support unit and a shaft according to an exemplary embodiment of the present invention. FIG. 12 is a view illustrating a state where an articulated robot and a delta robot are equipped instead of a support unit, a shaft and a galvano-scanner in an end-effector according to an exemplary embodiment of the present invention.

Referring to FIG. 1, for a high bed cultivation, there are provided a cultivation support unit 400 configured for strawberry to naturally suspend by its self-weight when strawberry is growing, and a plurality of legs 410 which are supported at a predetermined height.

Referring to FIGS. 1 to 7, the agricultural robot system 10 according to the present invention may include, but is not limited to;

a laser beam generator 250 provided to generate a laser beam;

a galvano-scanner 210 configured to perform a peduncle cutting or blossom thinning work by radiating the laser beam 251 from the laser beam generator 250;

a camera 220 which is installed facing a scanning surface 255 of the galvano-scanner 210 and is able to take pictures of fruits or flowers;

an image collection unit 910 which is able to take pictures of images containing the fruits or flowers from the camera 220;

an image recognition unit 920 which is able to recognize the fruits, peduncles and flowers from the images taken by the image collection unit 910; and

a target region detection unit 930 which is able to detect a peduncle cutting or blossom thinning target region from the image recognition information of the image recognition unit 920,

wherein the laser beam 251 scans the target region by driving the galvano-scanner 210 based on the target region information detected by the target region detection unit 930, thus performing a peduncle cutting or blossom thinning work or a peduncle cutting and blossom thinning work.

The agricultural robot system 10 according to the present invention will be described below.

The agricultural robot system 10 may include, but is not limited to, a main body 100 which is installed on the ground and is arranged movable on a rail 190 the length of which is almost same as the length in a longitudinal direction of the cultivation support unit 400 and which is installed parallel and includes a tray 110 formed of a moving device 980 and a control device 900 and configured to collect fruits, and a transfer unit 120 for transferring the fruits to the tray 110;

a shaft 160 which is installed on the top of the main body 100 and allows support unit 140 make easier upward and downward movements or rotations based on the number of floors and heights of the cultivation support unit 400;

an end-effector 200 which is formed of a laser beam generator 250 attached on a front end of the support unit 140 and configured to output a laser beam, a galvano-scanner 210 configured to perform a peduncle cutting or blossom tinning in such a way to radiate a laser beam from the laser beam generator 250 toward peduncles or flowers of fruits, a camera 220 configured to take pictures of fruits or flowers in the direction of the cultivation support unit 400, a lighting 230 provided for the sake of picture taking of the camera 220, and a spray nozzle 240 configured to spray air or liquid (liquid chemical and pollen-mixed liquid); and

a laser beam shield plate 310 which is formed contacting with a hopper 300 configured to collected fruits which drop after peduncles are cut and are fixed at the support unit 140 and the connection unit 150 and allows to prevent the laser beam radiated through the galvano-scanner 210 from deviating from the scope of the work region.

Preferably, as for the number of the cameras 220, one camera 220 is installed if the interval between the camera 220 and a subject (fruits or flower) is maintained constant within a predetermined range by installing the rail 190, etc., and multiple cameras (stereo cameras, etc.) may be installed in the environment where since the interval between the camera 220 and the subject (fruits or flower) is not constant, it needs to calculate a depth information (Z-axis: a distance between the camera and the subject) in the image or it needs to self-adjust the position and posture of the main body 100 and the end-effector 200 (refer to FIG. 11).

Preferably, the inner side of the hopper 300 is made of an elastic member so as to prevent any damages to the falling strawberry.

Preferably, the hopper 300 and the laser beam shield plate 310 may be installed attachable or detachable depending on the kinds of work and plants and cultivation environment.

Preferably, the position and posture of the end-effector 200 may be adjusted using a cartesian robot or an articulated robot or a delta robot instead of using the support unit 140 and the shaft 160 (refer to FIG. 11).

Preferably, the rail 190 may be installed on the ground or may be installed attached on the legs 410 or the cultivation support unit 400 or may be installed hanging from the top of the cultivation support unit 400 or may be installed between the cultivation support units 400 or the legs 410 which are arranged spaced apart from each other in parallel.

Preferably, the moving device 980 according to an exemplary embodiment of the present invention may be configured in such a way that the main body 100 can move on the rail 190, which however is not limited thereto. The main body 100 may be configured to move in various ways, more specifically, it may move using a line tracer or may move on a path previously stored in the control device 900 or a remote server.

Preferably, the air spray of the spray nozzle 240 in general is used if it needs to help pollination by allowing pollen to contact with pistol by making a wind or it needs to move the positions of fruits or flowers with the aid of force of wind.

Preferably, the blossom thinning in the present invention represents the thinning of blossoms or flower buds.

The agricultural robot system according to the present invention will be described with reference to FIG. 3, which may apply to various plants in such a way to form various types of end-effectors 200 each equipping with a plurality of galvano-scanners 210 and cameras 220 at the upper, lower, left and right portions of the main body 100, thus improving the speed, efficiency, etc. during the work.

Referring to FIG. 4, the galvano-scanner 210 disposed in the inside of the end-effector 200 may include, but is not limited to, an X-axis mirror 212 and a Y-axis mirror 214 configured to reflect the lease beam, and an X-axis mirror motor 211 and a Y-axis mirror motor 213 configured to rotate the X-axis mirror 212 and the Y-axis mirror 214.

In addition, at an end portion of the galvano-scanner 210 inside the end-effector 200, the laser beam generator 250 is installed so as to generating a laser beam.

Referring to FIG. 5, the laser beam 251 from the laser beam generator 250 reflects off the X-axis mirror 212 and the Y-axis mirror 214 of the galvano-scanner 210 and may be formed on the scanning surface 255 in various shapes of lines or regions and dots. With the laser beam, it is possible to cut, mark or burn metal, stone, fiber, etc. and form an optical indication depending on the output intensity of the laser beam generator 250.

The laser beam generator 250 is able to adjust and output the intensity of the laser beam 251 in accordance with a signal from the control device 900. When it needs to cut peduncle, the intensity of the laser beam 251 is increased, thus cutting the peduncle 501. When it needs to thin blossoms, the intensity of the laser beam 251 is decreased, thus curing or burning the pistol of the flower, whereupon the natural functions of the flower or blower buds can be stopped.

The camera 220 installed facing the scanning surface of the galvano-scanner 210 is able to transmit an image signal including fruits, flowers or flower buds which are growing on the cultivation support unit 400 and are suspending downward to an image collection unit 910 of the control device 900. (refer to FIG. 6)

Preferably, the laser beam generator 250 according to an exemplary embodiment of the present invention is installed at an end portion of the galvano-scanner 210, which however is not limited thereto. If the output capacity of the laser beam generator 250 is large, it may be installed at the man body 100. At this time, the path of the laser beam is guided so that the laser beam can be inputted into a predetermined portion of the galvano-scanner 210 through a mirror or an optical fiber, etc.

Preferably, the laser beam 251 is radiated using the scanning surface 255 so as to drive the galvano-scanner 210 in the present invention, which however is not limited thereto. There may be formed an end-effector 200 so as to radiate a laser beam 251 onto a predetermined portion of the scanning surface 255 in such a way to provide a delta robot 290 or a cartesian robot or an articulated robot instead of the galvano-scanner 210 (refer to FIGS. 10 to 12).

Referring to FIG. 6, the control device 900 of the agricultural robot system 10 according to an exemplary embodiment of the present invention may include, but is not limited to,

the image collection unit 910 configured to collect a flower image including fruits and flowers from at least one camera 220; an image recognition unit 920 configured to sort out the fruits and peduncles and flowers from the images obtained from the image collection unit 910 and calculate the states and number of the fruits, peduncles and flowers, a target region detection unit 930 configured to detect a target region of the peduncle cutting and blossom thinning depending on the states and number of the fruits, peduncles, flowers, flower buds, and flower stalks, a calibration unit 940 configured to calibrate the coordinates of the camera 220 and the galvano-scanner 210 and provide a correction information to the target region detection unit 930, and a control unit 950 configured to control the whole operations of the exemplary embodiments of the present invention, for example, the galvano-scanner 210, the transfer unit 120 and the moving device 980 and input and output signals externally.

Preferably, the image recognition unit 920 may include a function of calculating a correlation and a depth information using the sorted and recognized information from each image in case that the image corresponds to the images collected from the multiple cameras 220.

The operation will be described below with reference to FIG. 7, that is the flows of the agricultural robot system 10 according to an exemplary embodiment of the present invention.

First, in the step S10, it is determined if there is a work start instruction. The work start instruction method may be classified into a method wherein a worker inputs into an input device 960 of the control device 900, a method performed based on a previously set information, a method performed based on a remote control, etc. If the determination is negative, the routine becomes a standby while repeatedly performing the step S10 until there is a work start instruction. If positive, the routine goes to the next step.

In the step S20, the image collection unit 910 may collect the images from the input signals of the camera 220 and may transfer to the image recognition unit 920.

In the step S30, the image recognition unit 920 may extract and recognize fruits, peduncles, flowers, flower buds and flower stalks from the image and may label them and transfer to the target region detection unit 930 (refer to FIG. 8).

Preferably, the image recognition result may include a sorting value, a region information, a correlation, a state information, a labeling, etc.

Preferably, the image recognition condition may differ based on the kinds of plants and working environment and may be previously set and selected.

Preferably, the fruits may be sorted out and recognized as fruits and peduncles, and the flowers may be sorted out and recognized as flower leaves and pistils, and the flower buds may be sorted out and recognized as calyxes and flower leaves.

Preferably, the red fruits harvested may be recognized based on the facts that they have predetermined sized red regions, wherein a plurality of dots are uniformly distributed due to a plurality of seeds in the red region.

Preferably, green fruits may be recognized based on the facts that there are white regions larger than the predetermined sizes, and the red regions are smaller than the predetermined sizes, and a plurality of dots are uniformly distributed due to a plurality of seeds.

Preferably, the peduncles may be recognized based on the facts that they have long green shapes with an inclination in a predetermined range toward the upward side starting from the intermediate portion of the top of the calyx (green) covering the top of the fruits.

Preferably, the subject may be recognized as a flow if a pistil (a yellow high frequency region and a region containing a lot of small dots) and a stamen (a region which looks yellow and has a lower frequency than the pistil) can be extracted, and its edge looks like flower leaves(white) or may be recognized as a flow bud if a predetermined sized calyx (green) is formed close to a very small sized flow leave (white) which is not bloomed or very small sized flower leaves are contained in a predetermined sized calyx.

Preferably, the flower stalk may be recognized based on the facts that it is branched into a green and long line shape in upward and downward directions or at a predetermined inclination and into a plurality of peduncles.

Preferably, the image recognition unit 920 according to an exemplary embodiment of the present invention may be implemented in such a way to use in a single form or a double form a color image information, a gray image information and a black and white image information.

Preferably, the recognition of strawberry according to a preferred embodiment of the present invention has been performed by sorting into a red fruit and a green fruit, which however is not limited thereto. For example, the fruit thinning function may be performed in such a way to recognize both the deformed and infected strawberries together.

In the target region detection unit 930 in the next step S40, the fruits and flowers which satisfy the previously set conditions (color, quantity, correlation, position, etc.) for the peduncle cutting and blossom thinning may be detected as a work target region (refer to FIG. 9).

Preferably, the peduncle cutting and blossom thinning conditions may differ depending on the kinds of plants and working environments and in general are previously set. For example, if it is set that the sum of number of fruits and peduncles per one flower stalk are set not to exceed four, only four flowers or flower buds are left in order by summing the numbers of the fruits and flowers from the end portion (where fruits start forming) of the flower stalk, and the remaining flowers or flower buds are removed (refer to FIG. 9).

Preferably, the target regions (where the laser beam will be radiated) are designated in such a way that the fruits in a range of images are recognized as a peduncle cutting portion (a straight line shape with an inclination and a thickness) of a target fruit of the peduncle cutting, and in case of flowers, the whole portions (an atypical and solid circular or elliptical shape) of the pistil are recognized as a target region, and in case of flower buds, the center portions (a solid circular shape) of the flower calyx or flower leave are recognized as a target region. (refer to FIG. 9)

Preferably, the length and cutting position of the peduncle during the cutting of the peduncles may differ depending on the kinds thereof and working environment. For example, if there are any worries about damages to the fruits due to the collisions between the fruits, the length of the peduncle may be made very short so as to prevent any poking or the length thereof may be made as long as possible, thus preventing any damage to other fruits by letting the peduncle bend even when colliding with the other fruits.

In the next step S50, it is determined if there is a peduncle cutting and blossom thinning target region detected by the target region detection unit 930. If negative, the routine goes to the step S170 for execution, and if positive, the routine goes to the next step.

In the next step S60, it is determined if there is another blossom thinning work. If negative, the routine goes to the step S90 for execution, and if positive, the routine goes to the next step.

In the next step S70, the output is adjusted to the intensity of the laser beam corresponding to the blossom thinning work.

In the next step S80, it is an execution step for a flower thinning work. The laser beam scans in an order set with respect to each blossom thinning target region, thus finishing the blossom thinning.

In the next step S90, it is determined if there is a peduncle cutting target region. Here, if negative, the routine goes to the step S170 for execution, and if positive, the routine goes to the next step.

In the next step S100, the laser beam is adjusted to a peduncle cutting intensity.

In the next step S110, it is an execution step of a peduncle cutting work. The laser beam scans one peduncle in an order set by the target region detection unit 930 for cutting.

In the next step S120, it is determined (S140) if the peduncle cutting work in the step S110 has succeeded, and the images are recollected to correct the cutting positions of the remaining peduncles.

In the next step S130, the image recognition unit 920 extracts the fruits and peduncles from the images in the same way as in the step S30 and recognizes and labels and transfers to the target region detection unit 930 which corresponds to the next Step S140.

In the next step S140, it is determined if the peduncle cutting work performed in the step S110 has succeeded.

When the peduncle is cut by a laser beam, the fruits falls down due to its self-weight. If a corresponding fruit is not shown on the screen in the step S140, it means that the peduncle cutting work has succeeded, so the routine is positive, and the next step S150 is performed. On the contrary, if negative, the routine from the step S100 to the step S140 is repeatedly performed, and the peduncle cutting work is performed again with respect to the same peduncle cutting target region.

In the next step S150, within a result range of the image recognition in the step S130, the fruits are detected as a work target region, which fruits satisfy the peduncle cutting condition (color, correlation, position, etc.) previously set by the target region detection unit 930 in the same way as in the step S40.

In the next step S160, it is determined if there is a peduncle cutting target region detected by the target region detection unit 930 in the step S150. If positive, the routines goes to the step S100 to perform a new peduncle cutting work, and if negative, the routine goes to the next step S170.

In the next step S170, it is determined if there is a work finish instruction. If negative, the main body 100 is moved to the next work position, and the above procedures are repeatedly performed, and on the contrary, if positive, the routine is finished.

Therefore, the agricultural robot system according to the present invention allows a quick and accurate work while saving on workers for labor and manufacturing cost. It is possible to prevent any damages to plants and infections of bacteria and enhance the quality of fruits.

### INDUSTRIAL APPLICABILITY

The agricultural robot system according to the present invention allows a quick fruit harvesting and flower thinning work, whereupon it is possible to greatly save on workers and cost. The present invention may be used to prevent any damages to plants and infections of virus or bacteria while preventing any environment contamination, etc. due to the use of agricultural chemicals and more improving the quality of fruits.

What is claimed is:

1. An agricultural robot system, comprising:
a laser beam generator provided to generate a laser beam;
a galvano-scanner configured to perform a peduncle cutting or blossom thinning work by radiating the laser beam from the laser beam generator;
a camera which is installed facing a scanning surface of the galvano-scanner and is able to take pictures of fruits or flowers;
an image collection unit which is able to take pictures of images containing the fruits or flowers from the camera;
an image recognition unit which is able to recognize the fruits, peduncles and flowers from the images taken by the image collection unit; and
a target region detection unit which is able to detect a peduncle cutting or blossom thinning target region from the image recognition information of the image recognition unit, wherein the laser beam scans the target region using the galvano-scanner based on the target region information detected by the target region detection unit, thus performing a peduncle cutting or blossom thinning work or a peduncle cutting and blossom thinning work.

2. The system of claim 1, wherein there are provided a cartesian robot or an articulated robot or a delta robot instead of the galvano-scanner.
